(19) United States
(12) Patent Application Publication
(10) Pub. No.: US 2010/0052196 A1
(43) Pub. Date: Mar. 4, 2010

(54) OPTICALLY DRIVEN ACTUATOR AND METHOD OF MANUFACTURING THE SAME

(75) Inventors: Takayasu Yasuda, Minami-Ashigara (JP); Naoyuki Nishikawa, Shizuoka (JP)

Correspondence Address: GREER, BURNS & CRAIN, 300 S WACKER DR, 25TH FLOOR, CHICAGO, IL, 60606, US

(73) Assignee: FUJIFILM CORPORATION, Tokyo (JP)

(21) Appl. No.: 12/161,002

(22) PCT Filed: Jan. 19, 2007
(86) PCT No.: PCT/JP2007/051217

§ 371 Date: Jul. 15, 2008

(30) Foreign Application Priority Data
Jan. 27, 2006 (JP) 2006-019431

(51) Int. Cl. B29D 7/01; C08F 20/00

(52) U.S. Cl. 264/1.34; 526/312

(57) ABSTRACT

An optically driven actuator includes a crosslinked polymer obtained by crosslinking at least part of the side chains of a condensation polymer having, on its backbone chain, a photoisomerizable group that undergoes structural change under optical stimulation. The crosslinked polymer deforms reversibly depending on optical stimulation, thereby performing the function of an actuator.

### TECHNICAL FIELD

The present invention relates to an optically driven actuator that deforms under optical stimulation and a method of manufacturing the same.

### BACKGROUND ART

There have been increasing demands in the fields of medical instruments, industrial or personal robots, micromachines, etc. for small size, light-weight and flexible actuators.

Polymer actuators in particular have attracted considerable attention because of their flexibility, light weight, and noiselessness at the time of being driven. Of the polymer actuators, optically driven actuators that are driven by light are capable of supplying energy in a non-contact manner, do not need wiring for driving and are capable of eliminating noises generated in electric wiring, and therefore, their application particularly to industrial robots or micromachines used in the medical/nursing fields or aerospace field has been expected.

Studies on photoresponsive gels, as polymer materials that are driven under optical stimulation, have been actively conducted. For example, optical deformation of polyacrylamide gels containing the leuco form of a triphenylmethane, which is photoionizable, (Macromolecules, vol. 19, p. 2476 (1986)) and bending behavior of polyacrylamide gels when they are exposed to CO₂ infrared laser (J. Chem. Phys., vol. 102, p. 551 (1995)) have been realized. The deformation in the former example is due to the swelling of the gels caused by the increase in osmotic pressure of the gels which results from the optically induced ion-dissociation reaction. The bending behavior in the latter example is caused by the change in osmotic pressure of the gels which results from the volume change due to the heat generated by the infrared laser radiation. Besides polyacrylamide gels, polyimide gels that contain an azobenzene group, as a photoresponsive group, on its backbone chain have also been known (Japanese Patent Laid-Open No. 2005-23151). In such photoresponsive gels, however, the principle upon which they are driven is uptaking/discharging the molecules of a solvent, for example, water caused by a change in osmotic pressure across the gels, and therefore, a solvent is indispensable to drive the gels. Thus, such gels have presented the problem of being unfunctional in the dry environment.

For polymer materials that are driven under optical stimulation in the dry environment, a phenomenon was reported first that polyimides containing an azobenzene group contracted when exposed to ultraviolet light (Macromolecules, vol. 3, p. 349 (1970)). Such polymer materials are, however, problematic, when used as an actuator, in that they are driven only at high temperatures, their response speed is very low, and their contraction rate is very small.

Liquid crystal elastomer has lately been reported as an optically driven actuator usable in the dry environment. For example, it has been reported that liquid crystal elastmer obtained by crosslinking a polymer in the liquid crystal alignment state which contains an azobenzene group, as a photoresponsive group, on its side chain shows expanding and contracting behavior or bending behavior when exposed to ultraviolet light (Japanese Patent Laid-Open No. 2005-256031; Phys. Rev. Lett. vol. 87, p. 015501 (2001); Chem. Mater. vol. 16, p. 1637 (2004)). It has also been known that polydomain liquid crystalline elastomer obtained by crosslinking a polymerizable liquid crystal composition composed of an azobenzene derivative under light or heat can be bent in an arbitrary direction by exposure to polarized ultraviolet light (Nature, vol. 425, p. 145 (2003)).

However, any of the actuators of the above examples presents the problem of low speed of response to light and being able to function only in the form of a thin film because its response is largely decreased with increase in film thickness. Further, the actuators described in Chem. Mater. vol. 16, p. 1637 (2004) and Nature, vol. 425, p. 145 (2003) present the problem that their operating temperature or the like is limited because they are driven only in the liquid-crystal temperature range. Further, forming a self-supporting thin film is complicated because the process includes the steps of: coating a substrate with a monomer composition; curing the resultant film by long-time exposure to visible light; and removing the cured film from the substrate. Thus, there have been problems left unsolved in terms not only of performance, but of manufacturability.

In the light of the above problems, it is an object of the present invention to provide: an optically driven actuator that has photoresponsivity sufficient for its structure to deform reversibly at a practical response speed under optical stimulation, flexibility and light weight and is driven noiselessly; and an easy and simple method of manufacturing the same.

### DISCLOSURE OF THE INVENTION

The optically driven actuator of the present invention, which accomplishes the above object, is an optically driven actuator including a polymer that deforms under optical stimulation and utilizing the deformation of the polymer, wherein the actuator includes a crosslinked polymer obtained by crosslinking at least part of the side chains of a condensation polymer containing, on its backbone chain, a photoisomerizable group that undergoes structural change under optical stimulation, and wherein the crosslinked polymer deforms reversibly depending on optical stimulation and is functional as an actuator.

The optically driven actuator of the present invention includes a crosslinked polymer containing, on its backbone chain, a photoisomerizable group that undergoes structural change under optical stimulation and having its side chains crosslinked, thereby it can exhibit photoresponsivity sufficient for its structure to deform reversibly and at high speed depending on optical stimulation. Further, the optically driven actuator of the present invention is formed of a polymer, thereby it is flexible, light-weight and can be driven noiselessly. Furthermore, the optically driven actuator of the present invention can be prepared in large size simply and easily.

Preferably the crosslinked polymer is obtained by crosslinking a condensation polymer that has a repeating unit represented by the following general formula (1).

[Formula 1]

Z₁-Q-Z₂-L General formula (1)

In the above formula, Q represents a photoisomerizable group and L a divalent linking group or a single bond. Z₁ represents a divalent linking group selected from the group consisting of —OC(═O)—, —OC(═O)NR¹—, —C(═O)NR¹—, where R¹ is a hydrogen atom or optionally substituted alkyl group. These divalent linking groups may be linked in either direction. Z₂ represents a divalent substituent linked in the direction opposite to Z₁. Either of or both of Q and L have a crosslinkable group. As each of Q, L and Z₁, two or more of different kinds may be used.

The crosslinked polymer contains, in each repeating unit, a photoisomerizable group that undergoes structural change reversibly, thereby its photoresponsivity is enhanced.

Preferably the photoisomerizable group is an azobenezene group.

An azobenzene group is a photoisomerizable group that usually exists in the trans form, which is thermodynamically stable, but when exposed to ultraviolet light, it takes the cis form, and when exposed to visible light, again it takes the trans form. Thus, using an azobenzene group as a photoisomerizable group makes it easy to cause photoisomerization, thereby very high photoresponsivity can be obtained.

Preferably the azobenzene group is represented by the following general formula (2).

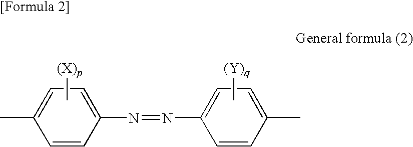

In the above formula, X and Y each represent a substituent, other than a hydrogen atom, which can be substituted on the phenyl group. The characters p and q each represent an integer of 0 to 4, provided that p+q≠0 and when p (or q) is 2 or more, X (or Y) may be the same or different.

Introducing a substituent, other than a hydrogen atom, which can be substituted on the phenyl group of azobenzene makes it possible to properly control the physical properties of the condensation polymer.

Preferably at least one of the substituents X and Y in the general formula (2) is a branched alkyl group.

Introducing a branched alkyl group which can be substituted on the phenyl group of azobenzene also makes it possible to properly control the physical properties of the condensation polymer.

Preferably the above optically driven actuator is in the form of a film.

An optically driven actuator formed into a film is more processable.

Preferably the above optically driven actuator is in the form of a film and has undergone stretching.

Such an optically driven actuator formed into a film and then stretched is more processable and more photoresponsive.

A method of the invention accomplishing the above object is a method of manufacturing an optically driven actuator, in which the actuator includes a polymer that deforms under optical stimulation and utilizes the deformation of the polymer, the method including the steps of: forming a film from a composition that contains a condensation polymer having a photoisomerizable group on its backbone chain; and stretching and crosslinking the composition that contains the condensation polymer.

According to the above method of manufacturing an optically driven actuator, an optically driven actuator having enhanced processability and photoresponsivity can be easily manufactured by forming a film to enhance processability and then stretching and crosslinking the film to enhance photoresponsivity.

According to the present invention, it is possible to provide an optically driven actuator having photoresponsivity sufficient to deform reversibly and at high speed depending on optical stimulation, flexibility and light weight and being driven noiselessly and an easy and simple method of manufacturing the same.

### BRIEF DESCRIPTION OF DRAWINGS

FIG. 1 is a flow chart illustrating one embodiment of the method of manufacturing an optically driven actuator of the present invention.

FIG. 2 is a diagram illustrating the evaluation experiment of photoresponsivity for the optically driven actuator of Example 3 of the present invention.

### BEST MODE FOR CARRYING OUT THE INVENTION

In the following, embodiments of the present invention will be described.

After intensive investigation, the present inventors have found that a crosslinked polymer obtained by crosslinking at least part of the side chains of a condensation polymer having a photoisomerizable group on its backbone chain shows photoresponsivity sufficiently high for its structure to undergo structural change reversibly by light and can be a material for optically driven actuators which has good processability.

The optically driven actuator of the present invention includes a crosslinked polymer obtained by crosslinking at least part of the side chains of a condensation polymer having a photoisomerizable group on its backbone chain (hereinafter sometimes referred to as photoresponsive crosslinked polymer).

The term “photoisomerizable group” used herein means a functional group that undergoes stereoisomerization or structural isomerization by light and moreover undergoes reverse isomerization by light having a different wavelength or heat. Of the compounds that have such a functional group and undergo structural change as well as color tone changes in the visible range, many are well known as a photochromic compound. Specific examples of such compounds include: azobenzenes, benzaldoximes, azomethines, stilbenes, spiropyrans, spirooxazines, fulgides, diaryl ethenes, cinnamic acids, retinals and hemithioindigoes.

The term “condensation polymers” used herein means polymers that can be synthesized by polycondensation or polyaddition; however, polymers obtained by cyclic polycondensation or cyclic polyaddition, (e.g. polyimides, polybenzoazoles, polyoxazoles, polypyrazoles and polyisooxazolines) are excluded in the present invention, because their polymer structure is rigid, and therefore, they are not preferable from the viewpoint of speed of response to light.

Examples of the above described condensation polymers include: polyethers, polysulfides, polysiloxanes, polyesters, polyamides, polycarbonates, polyurethanes, polysulfonates and polyphosphonates. Of these condensation polymers, polyesters, polyamides, polyurethanes and polycarbonates are preferable, and polyesters are most preferable.

Preferred examples of the condensation polymers are polymers having a repeating unit represented by the following general formula (1).

[Formula 3]

Z₁-Q-Z₂-L General formula (1)

In the general formula (1), Q represents a photoisomerizable group.

L represents a divalent linking group or a single bond, but preferably it is a divalent linking group. Preferably the divalent linking group is an optionally substituted alkylene group; an optionally substituted arylene group; a divalent linking group represented by the general formula (3) below; —O—, —C(═O)—, —N(R²)—, —S—, —S(O)—, —SO₂—, or a divalent linking group formed by combining two or more kinds of linking groups selected from the above, where R² represents a hydrogen atom or an optionally substituted alkyl group.

As an alkylene group, one having 2 to 18 carbon atoms is preferable and one having 4 to 12 carbon atoms is more preferable. As an arylene group, one having 6 to 24 carbon atoms is preferable, one having 6 to 18 carbon atoms is more preferable and one having 6 to 12 carbon atoms is much more preferable. Specific examples of particularly preferable arylene groups include phenylene and naphthalene groups.

Most preferably, L in the above formula is an optionally substituted alkylene group; an optionally substituted phenylene group; a divalent linking group represented by the general formula (3) below; —O—, —C(═O)—, or a divalent linking group formed by combining these linking groups.

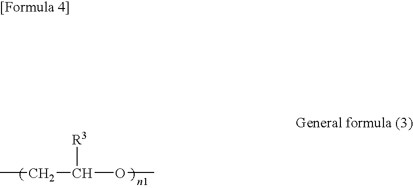

In the general formula (3), R³ represents a hydrogen atom or a methyl group. The number of the repeating unit n1 is preferably 1 to 25 and more preferably 1 to 10.

Z₁ represents a divalent linking group selected from the group consisting of —OC(═O)—, —OC(═O)NR¹—, —C(═O)NR¹—, where R¹ is a hydrogen atom or an optionally substituted alkyl group. These divalent linking groups may be linked in either direction. Z₂ represents a divalent substituent linked in the direction opposite to Z₁ (for example, when Z₁=—OC(═O)—, Z₂=—C(═O)O—).

In the general formula (1), either one of or both of Q and L have a crosslinkable group. The term “crosslinkable group” used herein means a functional group that is polymerized by the action of light or heat in the presence of an initiator or reacts with a crosslinking agent.

In the general formula (1), as each of Q, L or Z₁, two or more of the above definitions may be used.

For processes for synthesizing various kinds of condensation polymers, reference can be made to the processes described in “New Experimental Polymer Science 3, Synthesis/Reaction of Polymers (2), Synthesis of Condensation Polymers”, Chapters 2 and 3, edited by the Society of Polymer Science, Japan, published by Kyoritsu Shuppan, 1996. Particularly for processes for synthesizing polyesters, polyamides and polyurethanes, reference can be made to the document pp. 77-95, pp. 57-77 and pp. 229 to 233, respectively. In synthesis of polyesters or polyamides, in particular, the interfacial polycondensation process is preferably used because the process allows higher molecular-weigh polymers to be produced under moderate conditions.

The mass average molecular weight of the condensation polymer (uncrosslinked polymer) is generally 5,000 to 50,000, preferably 8,000 to 300,000 and more preferably 10,000 to 200,000. The condensation polymer having a mass average molecular weight in such a range is preferable because it offers a good balance of mechanical strength and moldability. The mass average molecular weight can be determined using gel permeation chromatography (GPC) in terms of polystyrene (PS).

Of the photoisomerizable groups, azobenzene groups are preferable, and particularly one represented by the following general formula (2) is preferable.

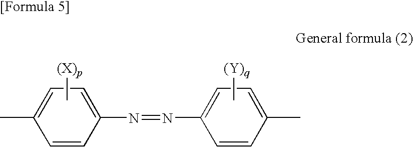

In the general formula (2), X and Y each represent a substituent, other than a hydrogen atom, which can be replaced on the phenyl group. Specific examples of substituents represented by X or Y include: halogen atoms; alkyl (including cycloalkyl), alkenyl (including cycloalkenyl, bicycloalkenyl), alkynyl, aryl, heterocyclic, cyano, hydroxyl, nitro, alkoxy, aryloxy, acyloxy, carbamoyloxy, amino (including anilino), acylamino, sulfamoylamino, mercapto, alkylthio, arylthio, acyl, aryloxycarbonyl, alkoxycarbonyl and carbamoyl groups. Of these substituents, halogen atoms and alkyl, alkenyl, aryl, alkoxy, aryloxy, acyloxy and alkoxycarbonyl groups are preferable, alkyl groups are more preferable, branched alkyl groups (e.g. isopropyl, sec-butyl and t-butyl groups) are much more preferable, and t-butyl group is most preferable.

The characters p and q each represent an integer of 0 to 4, provided that p+q≠0 and when p (or q) is 2 or more, X (or Y) may be the same or different.

The photoisomerizable group may be included not only on the backbone chain, but on the side chain or crosslinked group.

Preferably the amount of the photoisomerizable group contained in the photoresponsive crosslinked polymer is 0.1 mmols/g to 10 mmols/g and more preferably 0.5 mmols/g to 8 mmols/g in terms of the number of moles of the functional group per unit mass of the polymer.

The photoresponsive crosslinked polymer contained in the optically driven actuator of the present invention is a crosslinked polymer obtained by crosslinking the side chains of the above described condensation polymer. As a crosslinking process, any one of known and commonly used processes can be used. Specific examples of crosslinking processes include: a process which includes a step of synthesizing a condensation polymer described above, having a polymerizable functional group on its side chain; and a step of crosslinking the polymer in the presence of an initiator by light radiation or heating (process I); and a process in which the condensation polymer having a functional group on its side chain is crosslinked by adding a crosslinking agent reactive with the functional group of the side chain of the condensation polymer (if necessary, together with other additives such as a catalyst that accelerates the crosslinking) (process II).

The process I is applicable for example, when the crosslinkable group contained in the condensation polymer is an acrylate, methacrylate or acrylamide group. The process II is applicable, for example, when the crosslinkable group contained in the condensation polymer is an allyl or hydroxyl group. In this case, preferred examples of crosslinking agents used are H-terminated polydimethylsiloxane for allyl group and diisocyanate for hydroxyl group.

The percentage of the side chains crosslinked is preferably 0.5% by mol or more and 98% by mol or less of the crosslinkable functional group contained on the side chains of the condensation polymer, more preferably 1% by mol or more and 95% by mol or less and much more preferably 3% by mol or more and 90% by mol or less.

In the following, specific examples of the photoresponsive crosslinked polymers preferably used in the optically driven actuator of the present invention will be shown; however, the optical driven actuator of the present invention is not limited by these examples. In the following tables, the term “condensation polymer” represents the repeating unit structure of an uncrosslinked prepolymer, the term “crosslinkable group” represents a functional group that is contained in a condensation polymer and reacts with a crosslinking agent or a functional group that is polymerized with the aid of an initiator, and the term “percentage of the crosslinking agent added” represents the amount of the crosslinking agent added relative to that of the crosslinkable group in the condensation polymer (% by mol). The numerical values (values a, b, etc.) in the formulae represent the contents of the structural units in mole percentage.

TABLE 1

| Photo- | |
|---|---|
| responsive | |
| crosslinked | |
| polymer | Condensation polymer (uncrosslinked prepolymer) |
| P-1 | 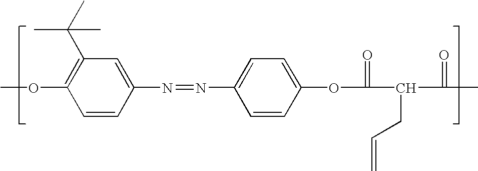 |
| P-2 | 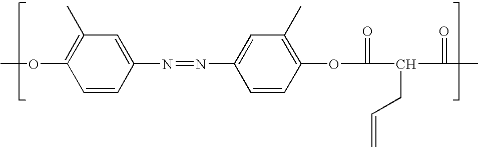 |
| P-3 | 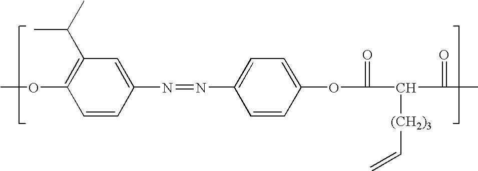 |
| P-4 | 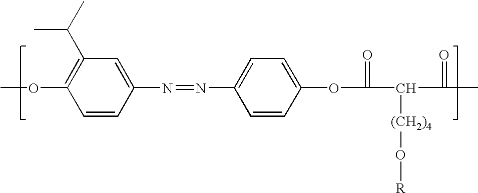 |
| | 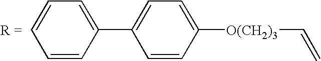 |
| P-5 | 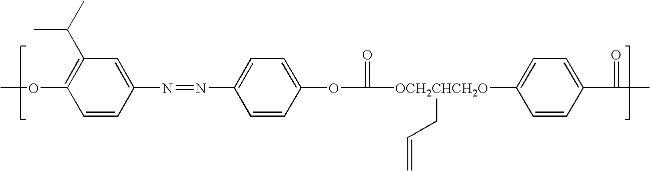 |
| P-6 | 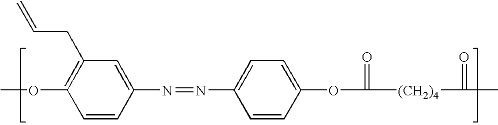 |
| P-7 | 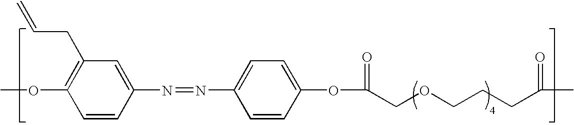 |

| Photoresponsive | | | |
|---|---|---|---|
| crosslinked polymer | Crosslinkable group | Crosslinking agent | Percentage of crosslinking agent added (mol %) |
| P-1 | Allyl group | 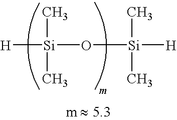 | 15 |
| P-2 | Allyl group | 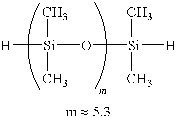 | 15 |
| P-3 | Allyl group | 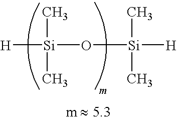 | 18 |
| P-4 | Allyl group | 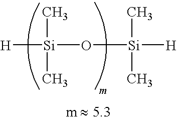 | 10 |
| P-5 | Allyl group | 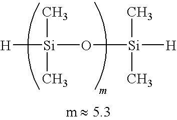 | 16 |
| P-6 | Allyl group | 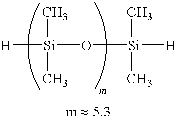 | 10 |
| P-7 | Allyl group | 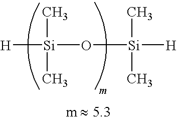 | 8 |

TABLE 2

| | |
|---|---|
| P-8 | 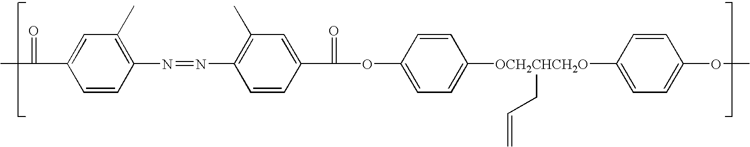 |
| P-9 | 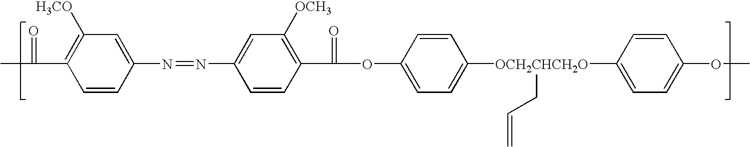 |
| P-10 | 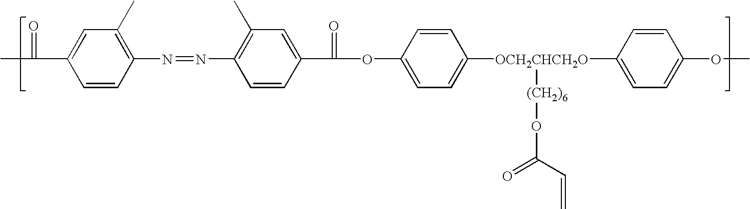 |
| P-11 | 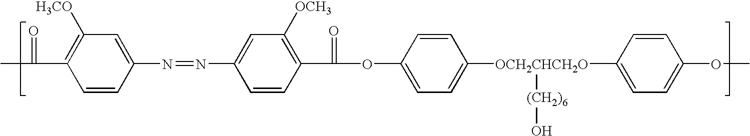 |
| P-12 | 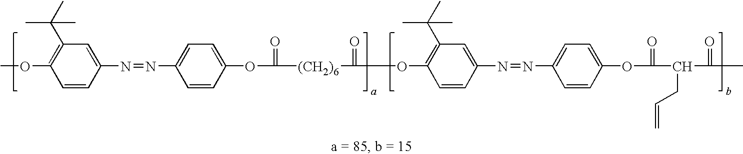 |
| P-13 | 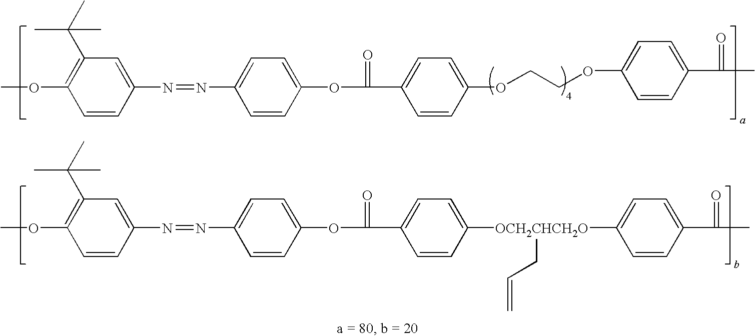 |
| P-14 | 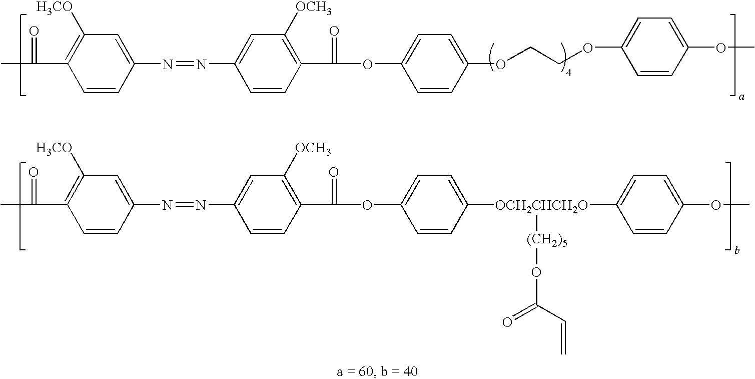 |

| | | | |
|---|---|---|---|
| P-8 | Allyl group | 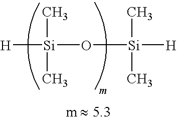 | 10 |
| P-9 | Allyl group | 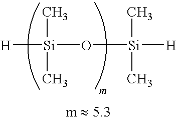 | 5 |
| P-10 | Acrylate group | — | — |
| P-11 | Hydroxy group | OCN—(CH₂)₆—NCO | 8 |
| P-12 | Allyl group | 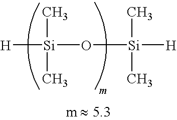 | 70 |
| P-13 | Allyl group | 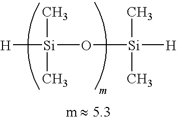 | 75 |
| P-14 | Acrylate group | — | — |

TABLE 3

| | |
|---|---|
| P-15 | 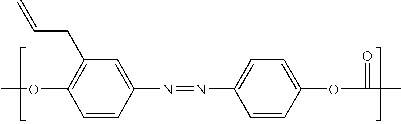 |
| P-16 | 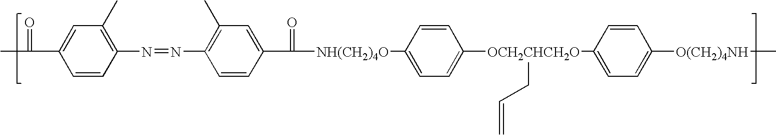 |
| P-17 | 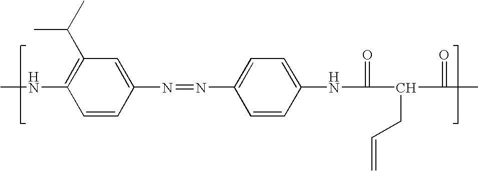 |
| P-18 | 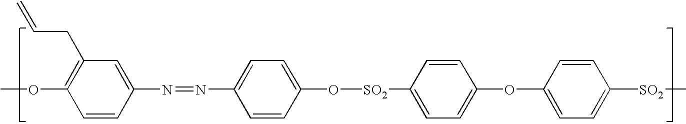 |
| P-19 | 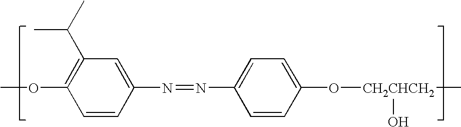 |

| | | | |
|---|---|---|---|
| P-15 | Allyl group | 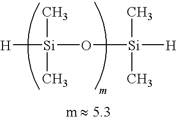 | 30 |
| P-16 | Allyl group | 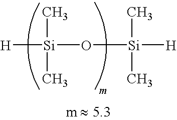 | 20 |
| P-17 | Allyl group | 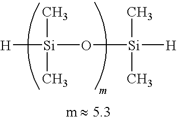 | 22 |
| P-18 | Allyl group | 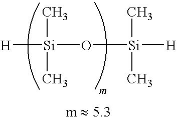 | 33 |
| P-19 | Hydroxyl group | OCN—(CH₂)₆—NCO | 12 |

TABLE 4

| | |
|---|---|
| P-20 | 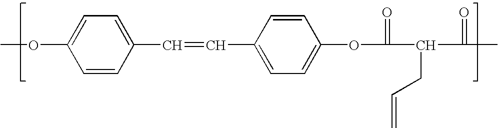 |
| P-21 | 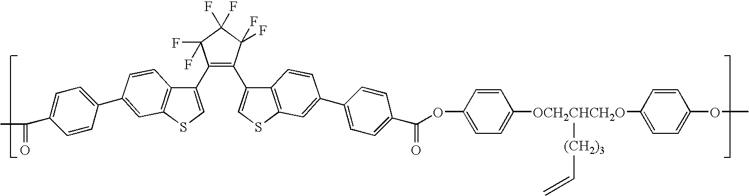 |
| P-22 | 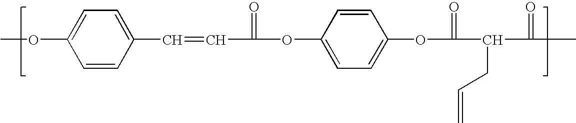 |

| | | | |
|---|---|---|---|
| P-20 | Allyl group | 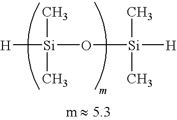 | 17 |
| P-21 | Allyl group | 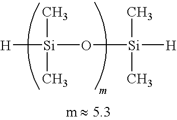 | 20 |
| P-22 | Allyl group | 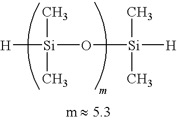 | 22 |

The optically driven actuator of the present invention may contain two or more kinds of the above described photoresponsive crosslinked polymers. It may also contain various kinds of polymers, other than the photoresponsive crosslinked polymers, so as to control the thermophysical properties such as glass transition temperature or mechanical properties such as modulus of elasticity. Further, various kinds of additives such as thermal stabilizers, antiaging agents, antioxidants, light stabilizers, plasticizers, softening agents, flame-retardants, pigments, foaming agents or foaming auxiliaries may also be used if necessary.

In the following, the method of manufacturing the optically driven actuator of the present invention will be described in detail.

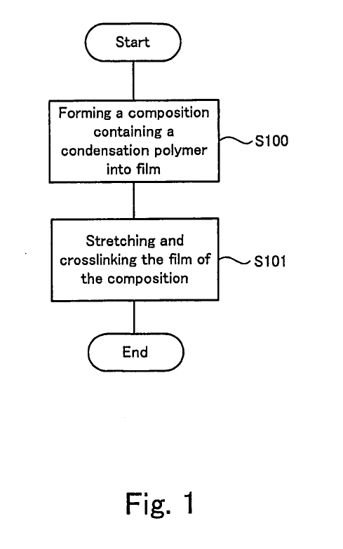

FIG. 1 is a flow chart illustrating one embodiment of the method of manufacturing an optically driven actuator of the present invention.

As a first step, a composition that contains a condensation polymer having a photoisomerizable group on its backbone chain (along with a crosslinking agent or a catalyst, if necessary) is formed into film (step S100).

Then, as a second step, the composition, which contains a condensation polymer having a photoisomerizable group on its backbone chain, formed into film is stretched and crosslinked (step S101).

The optically driven actuator of the present invention is manufactured through these steps.

More preferably, in the second step, the composition is stretched uniaxially or biaxially under stress during or after crosslinking.

As a process for forming the condensation polymer, any known and commonly used process can be used which has been reported as means of forming polymer. Examples of means of forming the above condensation polymer into film include a process for forming a film from polymer in the solution state or a process for forming a film from polymer in the molten state.

As a process for forming a film from polymer in the solution state, for example, a curtain coating, extrusion coating, roll coating, spin coating, dip coating, bar coating, spray coating, slide coating, print coating process and the like can be used.

As a solvent for the coating fluid used in the process for forming a film from polymer in the solution state, any known solvent in which a composition containing the condensation polymer can be dissolved or dispersed can be used. Specific examples of such solvents include: halogen solvents such as chloroform and dichloromethane; ketone solvents such as methyl ethyl ketone and cyclohexanone; and amide solvents such as dimethylformamide and dimethylacetoamide. Of these solvents, chloroform, methyl ethyl ketone, cyclohexanone and dimethylacetoamide are preferable, and chloroform, methyl ethyl ketone and dimethylacetoamide are particularly preferable. These solvents may be used in combination.

Bases preferably used in the process for forming a film from polymer in the solution state include: for example, not limited to, bases which are not swelled by or dissolved in the coating solvent. For drying the coating, any known drying process can be used. Specific examples of drying processes include room temperature drying, heat drying, blast drying and vacuum drying. Two or more of these drying processes may be used in combination.

The dried coating may be separated from the base or may be used together with the base as an optically driven actuator when the base is highly flexible.

As a process for forming a film from polymer in the molten state, hot-melt pressing, melt extruding and the like can be used. Examples of hot-melt pressing include: batch processes such as flat plate pressing and vacuum pressing; and continuous processes such as continuous roll pressing.

As a stretching process, stretching while heating, stretching while controlling humidity, or stretching while heating under controlled humidity can be used. Stretching while heating or stretching while heating under controlled humidity is preferable. The degree of stretching is preferably 1.01 to 10 and more preferably 1.1 to 5.

The light source used when driving the optically driven actuator of the present invention is not limited to any specific one, as long as it has wavelength suitable for the photoisomerizable group used. The light to be radiated may be polarized light or non-polarized light.

### EXAMPLES

The present invention will be described in further detail by the following examples; however, these examples are not intended to limit the present invention.

### Example 1

### Synthesis of Photoresponsive Crosslinked Polymer P-1 (Preparation of First and Second Optically Driven Actuators)

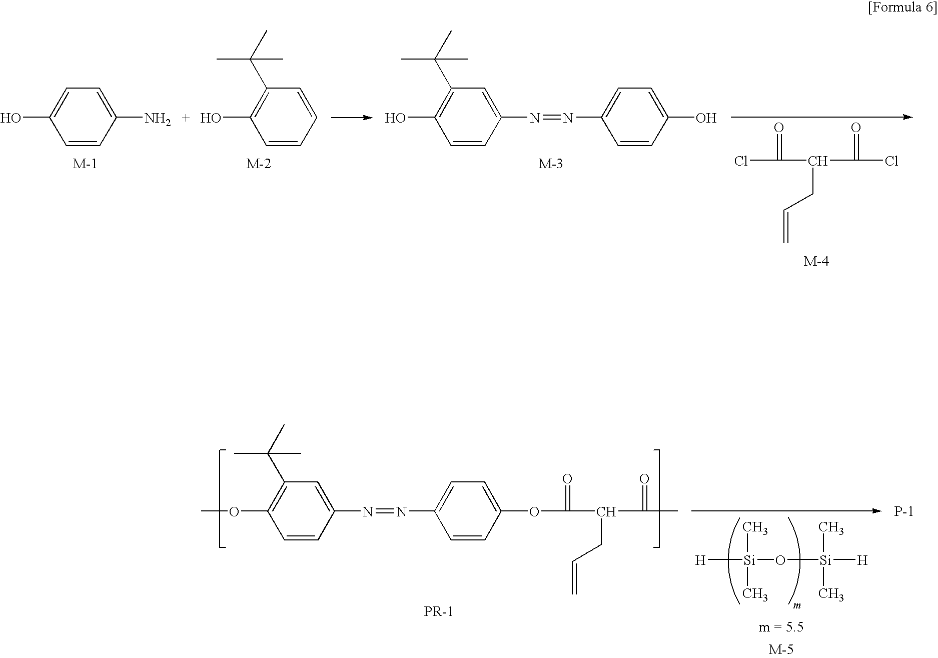

To an aqueous solution prepared by adding 90 ml of water to 22 ml of an aqueous solution of 37% by weight hydrochloric acid, M-1 (10.91 g, 0.100 mols) was added and cooled to 5° C. or lower. To this solution, an aqueous solution prepared by dissolving 7.59 g of sodium nitrite in 22 ml of water was added dropwise (internal temperature was 5° C. or lower). The mixed solution was stirred for 30 minutes while keeping the internal temperature at 5° C. to 10° C. The resultant solution was added dropwise to a solution of M-2 (15.02 g, 0.100 mol) in an aqueous solution of sodium hydroxide (sodium hydroxide: 16.12 g, water: 90 ml), while keeping the internal temperature at 5° C. or lower, and the mixed solution was stirred for 30 minutes. The resultant reaction product was added to an aqueous solution of 1 N hydrochloric acid (1.5 L), and the produced precipitate was filtered out and washed with an aqueous solution of sodium hydrogencarbonate and water. After drying, the precipitate was purified by silica gel column chromatography (solvent: hexane/ethyl acetate (3/1 (v/v))) to yield M-3 (20.67 g, 76.5 mmols).

M-3 (2.703 g, 10 mmols) was dissolved in an aqueous solution of sodium hydroxide (sodium hydroxide: 0.81 g, water: 100 ml), and to the resultant solution, tetra-n-butylammonium chloride (1.60 g, 5.76 mmols) was added. Then, a solution prepared by dissolving M-4 (1.81 g, 10 mmol) in 1,2-dichloroethane (30 ml) was added dropwise over 30 minutes, while vigorously stirring the solution, and stirred vigorously for another 30 minutes. To the resultant reaction product, 20 ml of methylene chloride was added so as to separate the organic layer. The separated organic layer was then washed with an aqueous solution of saturated sodium chloride and dried by adding magnesium sulfate. The solvent was distilled away to some extent to concentrate the organic layer, and the concentrated organic layer was added to methanol to be reprecipitated. The resultant precipitate was filtered and dried to yield PR-1 (3.6 g).

Then, PR-1 (380 mg), M-5 (70 mg) and platinum catalyst (dichloro(dicyclopentadienyl)platinum) (0.07 mg) were dissolved in chloroform (600 μL) to prepare a coating fluid. The coating fluid was then filtered through a microfilter (DISMIC-13 PTFE 0.45 MM: manufactured by ADVANTEC) and the filtrate was poured in a rectangular frame 1.5 cm×3 cm in size, which was prepared on a quartz glass plate using 80-μm Teflon (registered trademark) tape. The solvent was evaporated at room temperature for 12 hours to obtain a film (PR-2).

The resultant film (PR-2) was separated from the glass substrate with a razor's edge, heated at 90° C. for 10 hours in an atmosphere of nitrogen while stretched uniaxially at a stretching degree of 2.0, and vacuum dried at 90° C. for 3 hours to prepare a first optically driven actuator (film of 22 μm thick, 0.8 cm×2.5 cm in size).

On the other hand, the film (PR-2) was heated at 90° C. for 10 hours in an atmosphere of nitrogen, then vacuum dried at 90° C. for 3 hours, and separated from the glass substrate with a razor's edge to obtain a second optically driven actuator (film of 40 μm thick, 0.6 cm×1.2 cm in size).

### Example 2

### Synthesis of Photoresponsive Crosslinked Polymer P-12 (Preparation of Third, Fourth and Fifth Optically Driven Actuators)

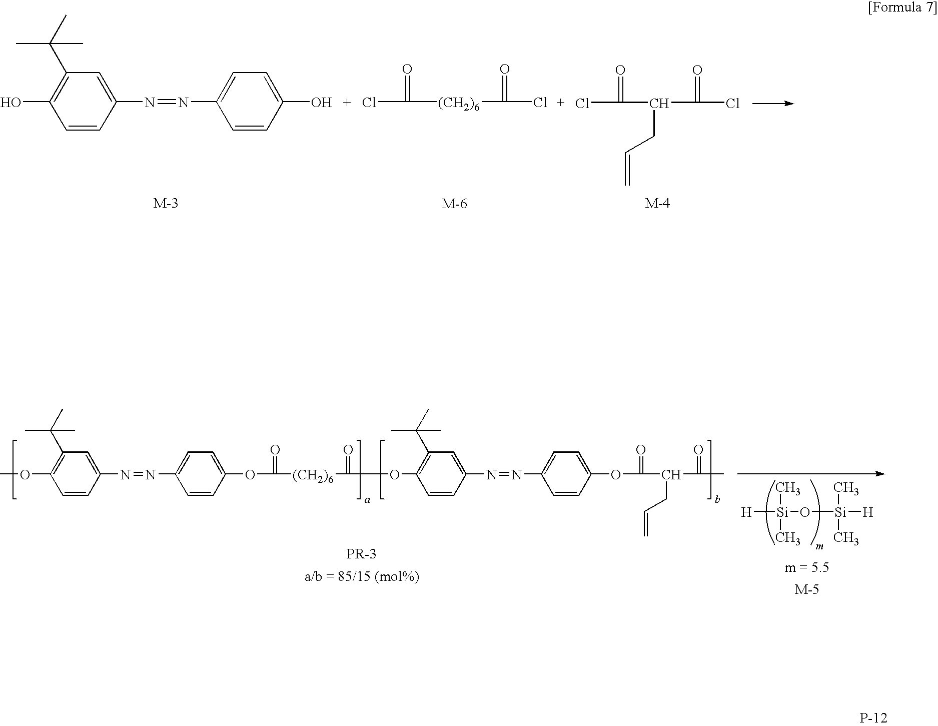

First, M-3 (2.703 g, 10 mmols) was dissolved in an aqueous solution of sodium hydroxide (sodium hydroxide: 0.81 g, water: 100 ml), and to the resultant solution, tetra-n-butylammonium chloride (1.60 g, 5.76 mmols) was added. Then, a solution prepared by dissolving M-4 (0.27 g, 1.5 mmols) and M-6 (1.79 g, 8.5 mmols) in 1,2-dichloroethane (30 ml) was added dropwise over 30 minutes, while vigorously stirring the M-3 solution, and stirred vigorously for another 30 minutes. To the resultant reaction product, 20 ml of methylene chloride was added so as to separate the organic layer. The separated organic layer was then washed with an aqueous solution of saturated sodium chloride and dried by adding magnesium sulfate. The solvent was distilled away to some extent to concentrate the organic layer, and the concentrated organic layer was added to methanol to be reprecipitated. The resultant precipitate was filtered out and dried to yield PR-3 (3.8 g).

Then, PR-3 (404 mg), M-5 (49 mg) and platinum catalyst (dichloro(dicyclopentadienyl)platinum) (0.05 mg) were dissolved in chloroform (600 μL) to prepare a coating fluid. The coating fluid was then filtered through a microfilter (DISMIC-13 PTFE 0.45 MM: manufactured by ADVANTEC) and the filtrate was coated on a quartz glass plate by spin coating (1000 rpm, 20 seconds) and dried at room temperature for 1 hour to obtain a film (PR-4).

Subsequently, the resultant film (PR-4) was separated from the glass substrate with a razor's edge, heated at 90° C. for 10 hours in an atmosphere of nitrogen while stretched uniaxially at a stretching degree of 2.3, and vacuum dried at 90° C. for 3 hours to obtain a third optically driven actuator (film of 25 μm thick, 1.0 cm×3.0 cm in size).

On the other hand, the film (PR-4) was heated at 90° C. for 10 hours in an atmosphere of nitrogen, vacuum dried at 90° C. for 3 hours, and separated from the glass substrate with a razor's edge to obtain a fourth optically driven actuator (film of 43 μm thick, 0.5 cm×1.0 cm in size).

Further, the fourth optically driven actuator was then uniaxially stretched at 100° C. at stretching degree of 2.5, relaxed at the same temperature for 3 hours, and cooled slowly to room temperature to obtain a fifth optically driven actuator (film of 29 μm thick, 0.3 cm×2.5 cm in size).

### Example 3

### Evaluation of Photoresponsivity for First, Third and Fifth Optically Driven Actuators

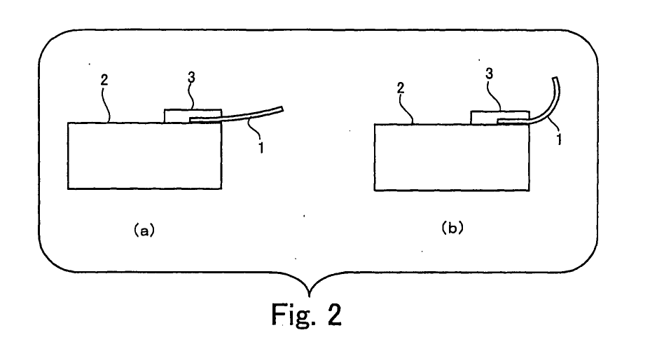

FIG. 2 is a diagram illustrating the evaluation experiment of photoresponsivity for the first optically driven actuator of Example 3 of the present invention.

Part (a) of FIG. 2 illustrates the state of the optically driven actuator before exposed to ultraviolet light. One end of the optically driven actuator 1 was fixed on the edge of the top surface of the stand 2 with clamps 3. The clamps 3 are made up of materials that intercept light.

Ultraviolet light of an intensity of 100 mW/cm² (365 nm) emitted an ultraviolet irradiator (EXECURE 3000, manufactured by HOYA CANDEO OPTRONICS) was applied to the first optically driven actuator 1 directly from above at room temperature.

Part (b) of FIG. 2 illustrates the state of the optically driven actuator 1 after ultraviolet radiation. As shown in part (b) of FIG. 2, the optically driven actuator 1 in the uniaxial stretching direction changed from horizontal state to bent state in 5 seconds. This confirmed that the optically driven actuator 1 was driven by light.

Further, visible light of an intensity of 50 mW/cm² (>500 nm) was applied to the optically driven actuator 1 in the bent state directly from above at room temperature. The result confirmed that the optically driven actuator 1 in the bent state was brought to the original horizontal state in 8 seconds.

Then, evaluation was performed for the third optically driven actuator obtained in the same manner as the evaluation experiment of photoresponsivity for the first optically driven actuator. The evaluation confirmed that third optically driven actuator in the horizontal state was brought to the bent state in 4 seconds by ultraviolet light radiation and the same actuator in the bent state was brought to the horizontal state in 7 seconds by visible light radiation.

The evaluation for the fifth optically driven actuator performed in the same manner as the above evaluation experiment of photoresponsivity for the first optically driven actuator confirmed that the fifth optically driven actuator in the horizontal state was brought to the bent state in 5 seconds by ultraviolet light radiation and the fifth optically driven actuator in the bent state was brought to the horizontal state in 7 seconds by visible light radiation.

### Example 4

### Evaluation of Photoresponsivity for Second and Fourth Optically Driven Actuators

Ultraviolet light emitted an ultraviolet irradiator (EXECURE 3000, manufactured by HOYA CANDEO OPTRONICS) was transformed to linear polarized light through a sheet polarizer and the linear polarized light of an intensity of 100 mW/cm² (365 nm) was applied to the second optically driven actuator which was obtained by the process described above directly from above at room temperature. The second optically driven actuator in the horizontal state was brought to the bent state along the transmission axis of the sheet polarizer in 17 seconds. This confirmed that the second optically driven actuator was driven by linear polarized light and the direction in which the actuator was bent could be controlled.

Further, visible light of an intensity of 50 mW/cm² (>500 nm) was applied to the second optically driven actuator in the bent state directly from above at room temperature. The result confirmed that the second optically driven actuator in the bent state was brought to the original state, horizontal state, in 30 seconds.

The evaluation for the fourth optically driven actuator performed in the same manner as the evaluation experiment of photoresponsivity for the second optically driven actuator confirmed that the fourth optically driven actuator in the horizontal state was brought to the bent state in 15 seconds by polarized ultraviolet light radiation and the same actuator in the bent state was brought to the horizontal state in 28 seconds by visible light radiation.

### Comparative Example 1

A self-supporting liquid crystal elastomer film (film thickness=42 μm) was prepared from the monomer/crosslinking agent described below (composition: A6AB2/DA6AB=50/50 (molar ratio)) in accordance with the process described in Chem. Mater. vol. 16, 1637 (2004). The film was exposed to ultraviolet light of an intensity of 100 mW/cm² (365 nm) emitted by an ultraviolet irradiator (EXECURE 3000, manufactured by HOYA CANDEO OPTRONICS) at 100° C. As a result, the film in the horizontal state was brought to bent state along the rubbing direction of the alignment film in 20 seconds. When exposed to visible light of an intensity of 50 mW/cm² (>500 nm) at 100° C., the film in the bent state was brought to the horizontal state in 45 seconds. On the other hand, when the film was exposed to ultraviolet light or visible light at room temperature under the same conditions, there was observed no change in the form of the film even after 2-minute continuous radiation.

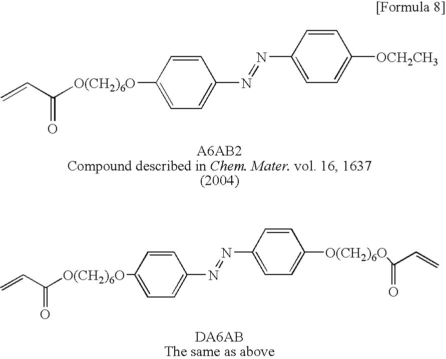

### Comparative Example 2

### Synthesis of Non-Crosslinked Polymer R-1 and Preparation of Optically Driven Actuator AR1

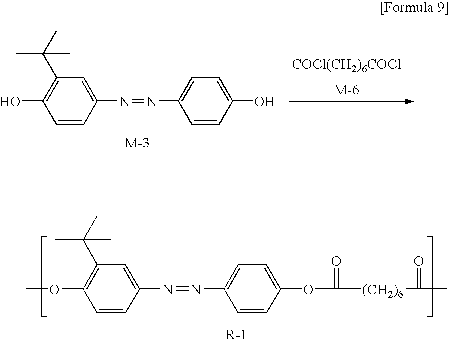

M-3 (2.703 g, 10 mmols) was dissolved in an aqueous solution of sodium hydroxide (sodium hydroxide: 0.81 g, water: 100 ml), and to the resultant solution, tetra-n-butylammonium chloride (1.60 g, 5.76 mmols) was added. Then, a solution prepared by dissolving M-6 (2.111 g, 10 mmols) in 1,2-dichloroethane (30 ml) was added dropwise over 30 minutes, while vigorously stirring the M-3 solution, and stirred vigorously for another 30 minutes. To the resultant reaction product, 20 ml of methylene chloride was added so as to separate the organic layer. The separated organic layer was then washed with an aqueous solution of saturated sodium chloride and dried by adding magnesium sulfate. The solvent was distilled away to some extent to concentrate the organic layer, and the concentrated organic layer was added to methanol to be reprecipitated. The resultant precipitate was filtered out and dried to yield R-1 (3.5 g). The weight average molecular weight of R-1 was determined, in terms of polystyrene, using GPC analyzer with columns TSK Gel GMHxL, TSK Gel G4000 H×L and TSK Gel G2000 H×L (trade names, all manufactured by Tosoh Corporation) and THF as a solvent, by differential refractometry. The determination was 77000.

R-1 (0.5 g) was formed into film by hot-melt pressing at 160° C. and 5 MPa using pressing machine (MINI TEST PRESS-10, manufactured by TOYOSEIKI). The film obtained was stretched at 60° C. at degree of uniaxial stretching of 2.0 to prepare an optically driven actuator AR1 (film of 60 μm thick, 1.0 cm×2.0 cm in size).

(Evaluation of Photoresponsivity for Optically Driven Actuator AR1)

Ultraviolet light of an intensity of 100 mW/cm² (365 nm) emitted from an ultraviolet irradiator (EXECURE 3000, manufactured by HOYA CANDEO OPTRONICS) was applied to the optically driven actuator AR1 obtained in the above manufacturing process at room temperature directly from above. As a result, the optically driven actuator in the horizontal state was brought to bent state along the stretching direction in 5 seconds. However, when the same optically driven actuator in the bent state was exposed to visible light of an intensity of 50 mW/cm² (>500 nm) at room temperature directly from above, there was observed no change in the actuator even after 1-minute or longer continuous irradiation.

Examples 3 and 4 and comparative examples 1 and 2 have proved that the first to fifth optically driven actuators of the present invention are superior to the actuator composed of a polymer that has a photoisomerizable group on its side chain (comparative example 1) in that they are driven at room temperature. The examples and comparative examples have also proved that the films having undergone stretching (the first, third and fifth optically driven actuators) give the advantageous effect of high response speed. Further, the examples and comparative examples have proved that the optically driven actuators of the present invention are superior to the actuator that has a photoisomerizable group on its backbone chain, but is composed of a non-crosslinkable polymer (comparative example 2) in that they are driven reversibly.

As described so far, according to the present invention, it is possible to provide: an optically driven actuator that has photoresponsivity sufficient for its structure to deform reversibly at practical response speed under optical stimulation, flexibility and light weight and is driven noiselessly; and an easy and simple method of manufacturing the same.

### INDUSTRIAL APPLICABILITY

The optically driven actuator of the present invention is applicable to active forceps, endoscopes, artificial muscles, drug delivery systems or biodevices in the field of medical/nursing care as well as driving parts of small size space probes, living-body imitating robots or artificial satellites in the field of aerospace. Further, it can be used in driving parts of ordinary equipment such as digital cameras, cellular phones, micropumps, touch displays or non-contact testers.

1. An optically driven actuator including a polymer that deforms under optical stimulation and utilizing the deformation of the polymer for an actuator, the actuator comprising:
a crosslinked polymer obtained by crosslinking at least part of the side chains of a condensation polymer having, on a backbone chain thereof, a photoisomerizable group that undergoes structural change under optical stimulation,
wherein the crosslinked polymer deforms reversibly depending on optical stimulation and is functional as an actuator.

2. The optically driven actuator according to claim 1, wherein the crosslinked polymer is obtained by crosslinking a condensation polymer having a repeating unit represented by the following general formula (1):
Z₁-Q-Z₂-L General formula (1)
wherein Q represents a photoisomerizable group; L a divalent linking group or a single bond; Z₁ a divalent linking group selected from the group consisting of —OC(═O)—, —OC(═O)NR¹—, —C(═O)NR¹—, where R¹ is a hydrogen atom or an optionally substituted alkyl group and these divalent linking groups may be linked in either direction; Z₂ represents a divalent substituent linked in the direction opposite to Z₁; either one of or both of Q and L contains a crosslinkable group and, as each of Q, L or Z₁, two or more of different kinds may be used.

3. The optically driven actuator according to claim 1, wherein the photoisomerizable group is an azobenzene group.

4. The optically driven actuator according to claim 3, wherein the azobenzene group is represented by the following general formula (2): 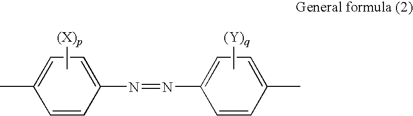
wherein X and Y each represent a substituent, other than a hydrogen atom, which can be substituted on the phenyl group; p and q each represent an integer of 0 to 4, provided that p+q≠0 and when p (or q) is 2 or more, X (or Y) may be the same or different.

5. The optically driven actuator according to claim 4, wherein at least one of the substituents X and Y in the general formula (2) is a branched alkyl group.

6. The optically driven actuator according to claim 1, wherein the actuator is in the form of a film.

7. The optically driven actuator according to claim 1, wherein the actuator is in the form of a film and has undergone stretching.

8. A method of manufacturing an optically driven actuator comprising a polymer that deforms under optical stimulation and utilizing the deformation of the polymer for an actuator, the method comprising the steps of:
forming a film from a composition comprising a condensation polymer that has a photoisomerizable group on a backbone chain thereof; and
stretching and crosslinking the composition comprising the condensation polymer.
